(19) United States
(12) Patent Application Publication
(10) Pub. No.: US 2014/0214489 A1
(43) Pub. Date: Jul. 31, 2014

(54) METHODS AND SYSTEMS FOR FACILITATING VISUAL FEEDBACK AND ANALYSIS

(71) Applicant: SocialGlimpz, Inc., San Francisco, CA (US)

(72) Inventors: Parminder Singh Bedi, Redmond, WA (US); Sam Prasad Kaipa, San Francisco, CA (US)

(73) Assignee: SocialGlimpz, Inc., San Francisco, CA (US)

(21) Appl. No.: 14/167,381

(22) Filed: Jan. 29, 2014

Related U.S. Application Data
(60) Provisional application No. 61/758,516, filed on Jan. 30, 2013.

(51) Int. Cl. G06Q 30/02

(52) U.S. Cl. CPC G06Q 30/0203
USPC 705/7.32

(57) ABSTRACT

A method and system for facilitating visual feedback and analysis over a network that has multiple users who each have a communication device, the method comprising facilitating posting a question to a selected number of consumers via the network; receiving, via the network, a response to each question from each responding consumer, wherein the response comprises a text message and an image (e.g., picture, a plurality of pictures, and a video); categorizing the response from each responding consumer; evaluating all responses in each category of responses by assigning a pre-established quantitative point value to each response; and ranking all responses using the quantitative point value.

### RELATED APPLICATIONS

This application claims priority to and the benefit of U.S. Provisional Patent Application No. 61/758,516 filed on Jan. 30, 2013, which is incorporated in its entirety herein by reference.

### FIELD OF THE INVENTION

The invention relates generally to social networking, and more particularly to systems and methods for facilitating the collection, distribution, and analysis of multimedia content within a mobile and social context.

### BACKGROUND OF THE INVENTION

Increasingly, the methods by which people interact and exchange information while “on the go” are being driven by the functionality available to them on their mobile devices. Initially, cellular phones allowed individuals to connect in real time without being tethered to a conventional telephone. As these devices matured, text messaging and email became a principal mode of communication. Later, with the advent of smart phone, cellular data service, and phone-based application (“app”) users could share thoughts, images, and experiences with their entire social network, as well as with the general public. Social media applications such as Twitter, Facebook, Viddy, and Instagram, for example, allow the instant sharing of thoughts, images, and experiences among their users.

However, much of the content generated by these applications is “pushed” from a user; which is to say that a user determines that something interesting is happening to or around him and posts the content to his network, regardless of whether anyone is actually interested in the content or whether the content is in fact accurate. Thus, the content is pushed upon others, who may or may not want it and who may or may not view it. In instances in which a consumer wishes to solicit input from others, e.g., “Is there a good Thai restaurant near the Berkeley campus?,” the result might include a simple string of text-based responses, some of which may have an address, or specific commentary, e.g., “Try the tofu pad thai!”. However, such responses fall far short or may fall short of the detailed information and reliability that the initiating consumer might want in response to such questions.

As a result, a new approach is needed to facilitate the solicitation and delivery of information, e.g., via social media, that permits multimedia content as part of the response, and, moreover, that analyzes and vets the responses, to determine those responses that are more accurate, valuable, and/or reliable.

In a first aspect, a method for facilitating visual feedback and analysis over a network having a plurality of users and including a memory and a processing device with each user of the plurality of users having a communication device is disclosed. In some embodiments, the method comprises facilitate, using the processor, posting a question(s) to a selected plurality of consumers via the network; receiving, via the network using the processor, a response(s) to each question from each responding consumer from the selected plurality of consumers, wherein the response(s) comprises a text message and an image (e.g., picture, a plurality of pictures, and a video); categorizing, using the processor, the response(s) from each responding consumer; evaluating, using the processor, all responses in each category of responses by assigning a pre-established quantitative point value to each response; and ranking, using the processor, all responses using the quantitative point value. In a variation of some of the embodiments, posting a question(s) to a selected plurality of consumers includes identifying a community of consumers likely to review and to respond to the at least one question.

For example, in some implementations, a likelihood of review and response among the community of consumers may be based on consumer data such as consumer demographics, consumer location, consumer psychographic characteristics, consumer attitudinal characteristics, consumer behavioral characteristics, historical consumer response times, historical consumer response frequency, and consumer interests. In other implementations, a likelihood of review and response among the community of consumers may be based on collected consumer names and a consumer's email address, a consumer's telephone number, and/or a consumer's cellphone number. In other implementations, a likelihood of review and response among the community of consumers may be based on an election by a discrete consumer to participate. For example, the election may result from a response to a query to participate and/or from a consumer subscription to participate.

In other embodiments, the method further comprises tagging an insight(s) to each image. In a variation, the method also includes determining a frequency of substantially similar insight tagging and ranking the responses using an insight tagging frequency.

In still other embodiments, the method comprises maintaining consumer engagement by minimizing idle time, by for example, determining historical consumer drop off patterns of a discrete consumer, a number of polls started by the discrete consumer, a number of polls completed by the discrete consumer, a number of polls partially completed by the discrete consumer, a number of followers of the discrete consumers, a number of fans of the discrete consumer; and/or a number of instances the discrete consumer conducts a search for a new poll to respond to. Furthermore, minimizing idle time may also include enabling a discrete consumer to view a poll response(s) and/or evaluation(s) attributed to a consumer with whom the discrete consumer is linked via a social medium.

In further embodiments, posting and receiving may be done synchronously or asynchronously. Asynchronous posting and receiving may include, for example, ascertaining a discrete consumer's location with respect to a predetermined location, establishing a geographical radius about the predetermined location, and/or posting the question(s) to the discrete consumer when the discrete consumer's location is within the geographical radius about the predetermined location. In some variations, this may include periodically tracking the discrete consumer's location. In other variations, the discrete consumer's location may be tracked continuously and a time boundary established, wherein the time boundary is established between a first time at which the discrete consumer receives a poll and a second time at which the discrete consumer provides a response to the poll.

In yet other embodiments, the method may include rewarding each responding consumer commensurate with the point value assigned to the responding consumer's response, which may include providing each responding consumer with a reward redeemable at a specific business location. In a variation of these embodiments, a value multiplier (e.g., a first multiplier to account for timeliness of a response, a second multiplier to account for a more positive response, and a third, negative multiplier to account for a more negative response) may be applied to the pre-established quantitative point value to each response. In other variations, rewarding each responding consumer of the plurality of consumers may be provided for providing personal profile information, referring other consumers to sign up, and participating in social media.

In another aspect, a system for facilitating visual feedback and analysis over a network having multiple users wherein each user has a communication device including a memory and a processing device is disclosed. In some embodiments, the system includes a non-transitory machine-readable medium storing information and a data processor(s) that is adapted to execute instructions stored in the non-transitory machine-readable medium. In a variation of these embodiments, execution of the instructions facilitate posting questions to a selected plurality of consumers via the network and receiving, via the network, responses to each question from each responding consumer from the selected plurality of consumers. The responses may include a text message and one or more images and may be categorized from each responding consumer. The responses are evaluated in each category of responses by assigning a pre-established quantitative point value to each response and ranked using the quantitative point value.

In variations of some embodiments, execution of the instructions may further tag an insight(s) to each image. In other variations, execution of the instructions determines a frequency of substantially similar insight tagging and ranks the responses using insight tagging frequency. In still other variations, execution of the instructions maintains consumer engagement by minimizing idle time by, for example, determining historical consumer drop off patterns of a discrete consumer, a number of polls started by the discrete consumer, a number of polls completed by the discrete consumer, a number of polls partially completed by the discrete consumer, a number of followers of the discrete consumers, a number of fans of the discrete consumer; and/or a number of instances the discrete consumer conducts a search for a new poll to respond to. In yet other variations, execution of the instructions periodically tracks a discrete consumer's location. In further variations, execution of the instructions continuously tracks the discrete consumer's location and establishes a time boundary, wherein the time boundary is established between a first time at which the consumer receives a poll and a second time at which the consumer responds to the poll.

In other variations, execution of the instructions facilitates the rewarding of each responding consumer commensurate with the point value assigned to the responding consumer's response. For example, in a first implementation, a value multiplier may be applied to the pre-established quantitative point value to each response. In a second implementation, each consumer may be rewarded for providing personal profile information, for referring other consumers to sign up, and/or for participating in social media.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 illustrates a screen capture of an exemplary embodiment of a Web page or mobile device user interface for inputting a poll question and for establishing demographics for a poll question in accordance with some embodiments of the present invention;

FIG. 2 illustrates an exemplary mobile device screen capture of an image sent in response to a poll question;

FIG. 3 illustrates an exemplary mobile device screen capture of an image and text message to be sent in response to a poll question;

FIG. 4 illustrates an exemplary mobile device screen capture of an evaluator's interface in accordance with some embodiments of the present invention;

FIG. 5 illustrates an exemplary mobile device screen capture that shows responses from three other consumers, which a current consumer may access in accordance with some embodiments of the present invention;

FIGS. 6A through 6F illustrate exemplary Web pages and/or mobile device screen captures of embodiments of a poll summary or portions thereof in accordance with some embodiments of the present invention;

FIG. 7 shows a context diagram of a distributed system configured to provide a crowd-based polling platform in accordance with some of the embodiments of the present invention; and

FIG. 8 shows an illustrative computer system in accordance with some embodiments of the present invention.

### DETAILED DESCRIPTION OF THE INVENTION

In various embodiments, the invention provides methods and supporting systems that facilitate combining responses for questions posted via social media or directly across a network, and ranking the individual responses to the questions. More particularly, the invention provides methods and supporting systems that facilitate posting questions directly to certain users of the system or, alternatively, using various social networking platforms to distribute questions. The users may be “related,” e.g., a “fan,” a “follower,” and so forth, which is to say that the users have self-selected each other as “connections” within at least one common social graph, or “unrelated,” in that they have no formal connections linking them. In some instances, there may be a mixture of related and unrelated network users. Advantageously, the system uses the power of a user “community” and, in some cases, the public in general to analyze, vet, confirm, rank, and otherwise review questions and responses.

Typically, a network user (“polling individual”) asks, poses or posts a question and identifies a set of targeted recipient segments (“consumers”) to respond to the question. The targeted recipient segments may be selected based on demographics, on a demonstrated or historical willingness to answer prior questions, chosen at random, or some combination thereof. For example, a leading laundry detergent manufacturer—in this example the “user”—might be interested in understanding how a certain, discrete demographic of frequent business travelers—in this example, the “targeted recipients” or “consumers”—keeps their clothes clean and ask “Show us how you keep your clothes clean on the go.” The question may then be transmitted to pre-selected consumers across and/or within certain segments, such as males over 40 that have taken more than five business trips in the past year. The question may be transmitted to the consumers via, for example, a mobile application, a mobile web browser, email, MMS message, SMS message, and so forth, and may include an embedded link to a response page. Preferably, the recipients of the question, i.e., the “consumer,” answer with a few words of text, e.g., less than about 140 characters in some cases, and at least one image, e.g., a picture, a plurality of pictures, a video, and the like. For the purpose of clarity, the term “users” will refer to those who ask, pose or post a question via a network and the term “consumers” will refer to those receiving (and responding) to a post, keeping in mind that depending on the situation, a “user” in one situation may be a “consumer” in another situation. The terms are fluid as an individual or business may find itself transitioning from the role of a user to that of a consumer rapidly.

The image and text combination response may then be vetted through a process of peer reviews using a social circle based on various targeting parameters and on historical behavioral data. The results may then be collated, aggregated, and processed to reveal insights and true consumer sentiment.

More specifically, the process and platform operate in four phases—(a) recruiting and engaging a response panel; (b) intelligently targeting and collecting data in the form of responses from a specific set of consumers; (c) evaluating and analyzing the data generated to glean insights and to remove errors; and (d) summarizing and reporting the resulting data.

### Recruitment and Engagement Phase

The recruitment process is aimed at identifying and engaging a community of consumers, i.e., “a virtual response panel,” to review and respond to content as it is created, posted, and distributed. The members of the community of consumers may be tagged with one or more parameters, such as demographics, historical response times, historical response frequencies, stated or historical interests, and so forth such that virtual response panels can be created in real time based on one or more of the parameters and the extent that they closely or most closely match those of the content being or to be reviewed.

In some instances, the community may be built or assembled through partnerships with research firms, brands, product manufacturers, and the like. For example, a brand may own a database of platform-specific or application-specific consumer usernames, consumer names, consumer email addresses, and/or consumer cellphone numbers that the brand may be willing to share. When these databases are shared, consumers may be contacted, e.g., via MMS, SMS, email, text message, mobile app, mobile web browser, and the like, and asked to participate in the community generally or as part of a specific response panel. In some instances, content sent to consumers may be limited to content created by or vetted by the brand itself, whereas in other instances, consumers may receive content related to a variety of brands or topics.

In other cases, social media and/or search engine optimization techniques may be used to intelligently identify consumers willing—and, more preferably, more likely—to participate, viz. to review and respond, in virtual response panels. In specific implementations, sponsored posts or advertisements may be presented, e.g., in news streams, on web pages, or other messaging modalities, such that a consumer may elect to be included in the community. For example, an advertisement prominently displayed on a search result Web page may offer a consumer a discount on a particular product or brand if the consumer signs up and agrees to review and/or respond to posted content about a particular topics. The ads may be designed to aggressively coax or enlist consumers or may be less aggressive and merely ask consumers to subscribe for a poll.

To maintain community engagement, consumers may, voluntarily or on their own initiative, subscribe to other consumer's posts and reviews; view another consumer's news stream or feed to see the content they have reviewed; and allow other consumers to add comments. In some cases, contests and games may be built around the content and responses, such that consumers can compete for status on certain types of content, e.g., a ranking as an “expert on sushi restaurants in the Boston area”, and be designated as such either within their network or across the entire community.

Consumers may also be rewarded for their participation. For example, “points” may be awarded to consumer responses and response evaluations and the points may be redeemed for cash, gift cards, coupons, goods, products, charitable donations, and the like. The system may further reward consumers for a variety of other activities that may include—for the purpose of illustration and not limitation—social participation (e.g., “liking”, commenting on responses, “following”, being followed, posting responses to social media), providing consumer profile information, referring other consumers to sign up and participate, and so forth.

Advantageously, a variable number of points may be awarded to provide a value that is proportional to desired behaviors and task difficulty as a measure of activity, speed, and quality, for example. Indeed, each activity may also include an associated point multiplier that adjusts the value. For example, a first poll question: “Show us the décor at your favorite restaurant” may have a higher point multiplier than a second poll question: “Show us your favorite pair of shoes,” because, presumably and logically, it is less likely that, when the question is posed, a consumer will be located at her favorite restaurant and able to take a picture of it. If a poll is responded to in a timely fashion, point multipliers may be higher. Lastly, if a response was evaluated in a highly positive manner by, for example, a peer evaluation group for its sentiment and quality, a higher point multiplier might be assigned. The opposite may also be true, which is to say, if an evaluated response is of poor quality, the point multiplier might be lower, and in some cases, may be zero.

In most cases, the points awarded may be general in nature and universally redeemed for a host of goods, products, services, discounts, discount coupons, and so forth. In other embodiments, however, consumers may collect and store/save reward points specifically for a particular brand or topic and may redeem the stored/saved points accordingly. For example, a consumer may provide valuable feedback while on the scene at a particular nightclub, e.g., “long lines but friendly staff and great music”, and, as a reward, may receive points that are redeemable at that club only, at a similar, competing club, and so forth.

One challenge to maintaining engagement is minimizing a consumer's idle time between receiving requests and responding to content. In some instances, a threshold for a discrete consumer or for the community of consumers may be calculated to indicate the amount of time after which the discrete consumer and/or an average or typical consumer will likely drop off from the platform. Reasons contributing to disengagement may include a lack of polls being sent to them for response, or too great a time between polls being provided. For example, the threshold may be calculated based in part on a statistical analysis of historical consumer drop-off patterns for the discrete consumer and for the average, typical consumer, the number of times the discrete consumer opens the application to check for new polls, the number of times the average, typical consumer opens the application to check for new polls, the number of polls started by the discrete consumer, the number of polls started by the average, typical consumer, the number of polls completed by the discrete consumer, the number of polls completed by the average, typical consumer, the number of polls partially completed by the discrete consumer, the number of polls partially completed by the average, typical consumer, the number of followers/fans/social media connections of the discrete consumer, the number of followers/fans/social media connections of the average, typical consumer, points awarded, points redeemed, and so forth.

With the above information, polls and/or evaluation opportunities may be provided more frequently, especially for consumers that are likely to drop at a lower threshold. If actual consumer polls are not available for a period of time or if a particular targeted response segment has not received a poll, pre-developed stock polls may be used as “seed” polls. Similarly, if a consumer registers as a new participant, a set of pre-developed polls may be sent to her immediately so that the new consumer does not have to wait for more targeted polls. New consumers may receive polls associated with other consumers that the new consumer follows, is a fan of, and/or with whom the new consumer has established a social connection. New consumers may also receive a poll that others who follow, are a fan of, and/or have established a social connection with the same related consumer have historically been fed.

Similarly, all consumers may receive a “feed” that includes activities generated by the consumers they follow, are fans of, and/or have established a social connection with. Advantageously, consumers may be allowed to view, as the main example, the responses to polls and evaluation of responses of related consumers they follow, are fans of, and/or with whom they have established a social connection. Preferably, the feed is populated at the time the responses are submitted. However, if a consumer registers as a new participant and immediately follows, becomes a fan of, or establishes a social connection with several consumers, the system may send historical consumer activities to the feed so that the new consumers do not have to wait for future consumer events. As such, the system is designed to promote engagement and continued use of the application, leading to greater usage and more valuable data.

### Targeting and Data Collection

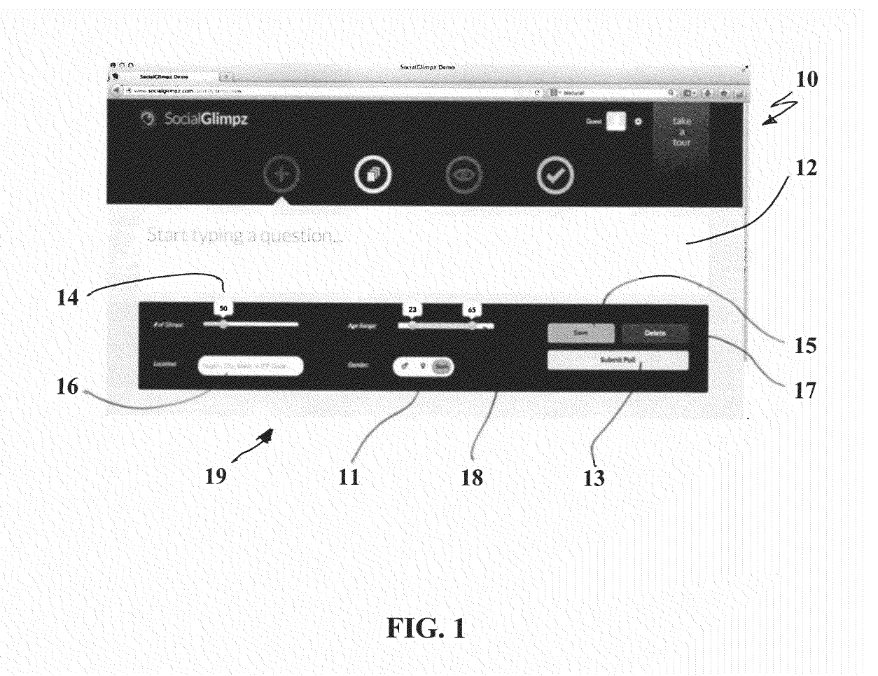

Using either an online portal or a mobile app that may be downloaded onto a mobile device, a network user (“polling individual”) can pose a question and target respondents (“consumers”) based on a combination of geographical location, demographic, psychographic, attitudinal, and behavioral characteristics. The application enables a one-to-many question/answer paradigm for mobile users, in that a polling individual (“user”) may ask a question, and may receive multiple responses from poll respondents of target responders (“consumers”) via their mobile devices. FIG. 1 illustrates an exemplary Web page or user interface 10 with which a user may design a poll and structure a consumer profile. For example, the Web page/user interface 10 may include an area 12 for inputting, e.g., typing or keying in, a question or post and an area 19 for initially targeting consumers to answer the question. For the purpose of illustration and not limitation, the area 19 for targeting consumers may include a gender selector 11, a location (e.g., region, street, city, state, zip code, and so forth) selector 16, an age range selector 18, and a language selector 21. Other illustrative function keys include a save button 15 for saving the question and target information, a delete button 17 for deleting all information, a submit button 13 for submitting the post, and a number of responses selector 14. Advanced options may include, again for the purpose of illustration and not limitation: a home ownership selector, an income range selector, a marital status selector, a number of dependents selector, an age or range of ages of dependents selector, a profession selector, a language selector, a height/weight selector, and so forth.

The poll question may be sent over a network using a system via push notification or, in some cases, added to a list of active polls that are made or may be made available to consumers via a mobile app installed on consumers' smartphones. In cases in which consumers do not have a smartphone or do not have the app loaded on their phone, they may register on a designated Website to receive the poll question via MMS, SMS, email, text message, and so forth, on their phone. The consumer may respond to the poll question using text, e.g., via MMS, SMS, email, and the like, and/or by directly uploading an image, e.g., at least one picture, a video, and the like, on their phone and transmitting the content, e.g., using a social medium (e.g., Twitter, Facebook, Viddy, Instagram, and so forth), to a collection and processing site described in greater detail below.

The sending of polls and responses may be done synchronously, i.e., in real time, or asynchronously. Synchronous transmission may be used in cases where the precise geographical location of the consumer at the time of the post is not critical. For example, a user may post a poll asking “what is your most favorite piece of furniture in your house” and target the poll at people (“consumers”) living in the 98103 zip code with a household income greater than $100,000. Such polls may stay active for a certain amount of time as the temporal nature of the poll is not important.

In contrast, some polling questions may be designed for asynchronous delivery. For example, this may be the case when the poll is being directed at a particular/discrete consumer or based on a specific event. For example, selected consumers may be presented with a poll question such as “what is something you desire but can't afford?” as soon as they walk into an electronics or computer store, or “what is your favorite type of coffee drink?” as they approach a coffee shop.

To implement asynchronous polling, the system may be configured and arranged to ping a plurality of identified mobile devices that are within a pre-defined geographical radius, e.g., within a block, two blocks, 1 mile, 10 miles, and so forth, of a location related to the poll, e.g., XYZ Electronics or ABC Coffee, and, further, to transmit all relevant polls to mobile app consumers within that radius. In some instances, a particular asynchronous poll may be hidden from the consumer, i.e., it does not appear in their poll list. The system may then periodically track, e.g., every hour, every n minutes, and so forth, movement of potential, responding consumers with respect to the location related to the poll and the geographical radius. If, for example, a potential responding consumer enters the location related to the poll, the poll may become “active” on the potential responding consumer's device. Whereas if the potential responding consumer moves away from location related to the poll or outside of the geographical radius, the system may invalidate the poll after a given duration of time.

Commercial, industrial use of the system may require user-companies or user-brands to continuously track the geographical location of potential, responding consumers by, for example, tracking a customer through a retail store to gain insights into shopping habits and trends both generally and for that particular individual. However, continuous GPS mobile tracking can drain a device's battery life and cause a spike in data usage rates. Advantageously, the integrated polling/response gathering system may be adapted to enable polling users to interrupt, i.e., to time bound, the “continuous” tracking process, to reduce the drain on battery life and data usage. For example, once a targeted consumer's location has been identified in a mall, the consumer may receive the poll: “show us your favorite shoe at RST Shoe Store.” Prior to transmitting the poll to the targeted consumer, tracking would not necessarily have been continuous. However, after the poll has been transmitted and received, the system may be structured and arranged to begin continuous location tracking of the polled consumer. Such tracking may continue uninterrupted until receipt of a transmitted response or the expiration of a pre-designated period of time for responding, at which point in time continuous tracking associated with the “favorite shoe” poll ceases.

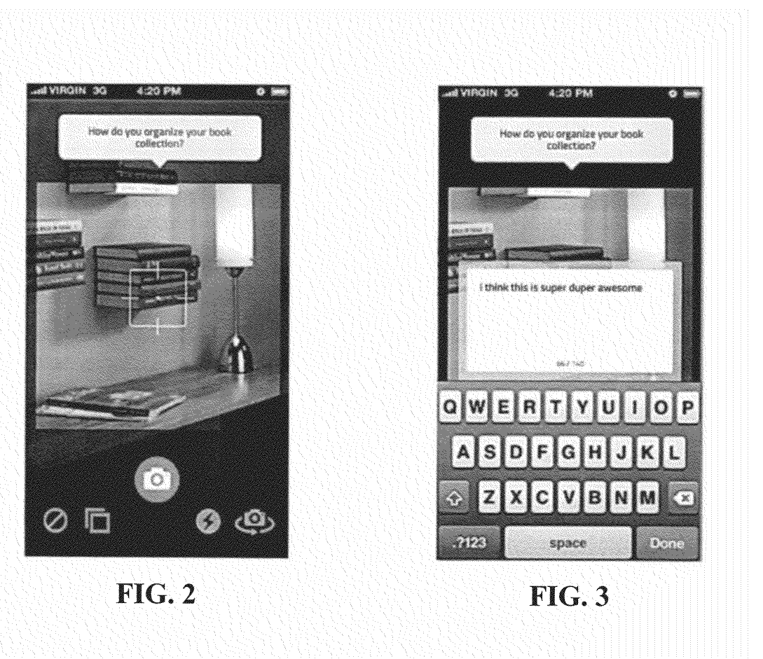

In some embodiments, consumers' responses to questions may take the form of a combination of an image, e.g., one or more pictures and a short text message (e.g., less than 140 characters); a video and a short text message; and the like. In other embodiments, consumers may respond to the question(s) with just a video or pictures. For example, FIG. 2 illustrates an exemplary mobile device screen capture that includes just a picture of a book organizer transmitted in response to the question “How do you organize your book collection?” FIG. 3 illustrates an exemplary mobile device screen capture that includes a picture of a book organizer and text message to be transmitted in response to the same question.

### Evaluation

Poll responses may be published or otherwise transmitted to an “evaluation panel” for qualitative analysis. The evaluation panel rates and comments on each response; essentially answering the question “how well does this response to {original question inserted here} resonate with you?” More specifically, the system concatenates each response into a group that, preferably, includes approximately five responses. For example, if 20 responses to a specific poll question are received, the responses may be separated into four “buckets” of five responses each. Each bucket of five responses may then be transmitted to multiple randomly-selected member of the evaluation panel so that more than one evaluation panel member (“evaluators”) looks at each bucket. Typically, at least five evaluators may be assigned to evaluate each bucket. Accordingly, for the present example, 20 evaluators would be needed to evaluate the four buckets.

Each member the evaluation panel evaluates one bucket of, typically, five responses, before being asked if she would like to evaluate another bucket. If an evaluator indicates a desire to evaluate another bucket, the next bucket of responses is sent to her for review. This process may continue until the member has had enough or there are no more buckets to evaluate.

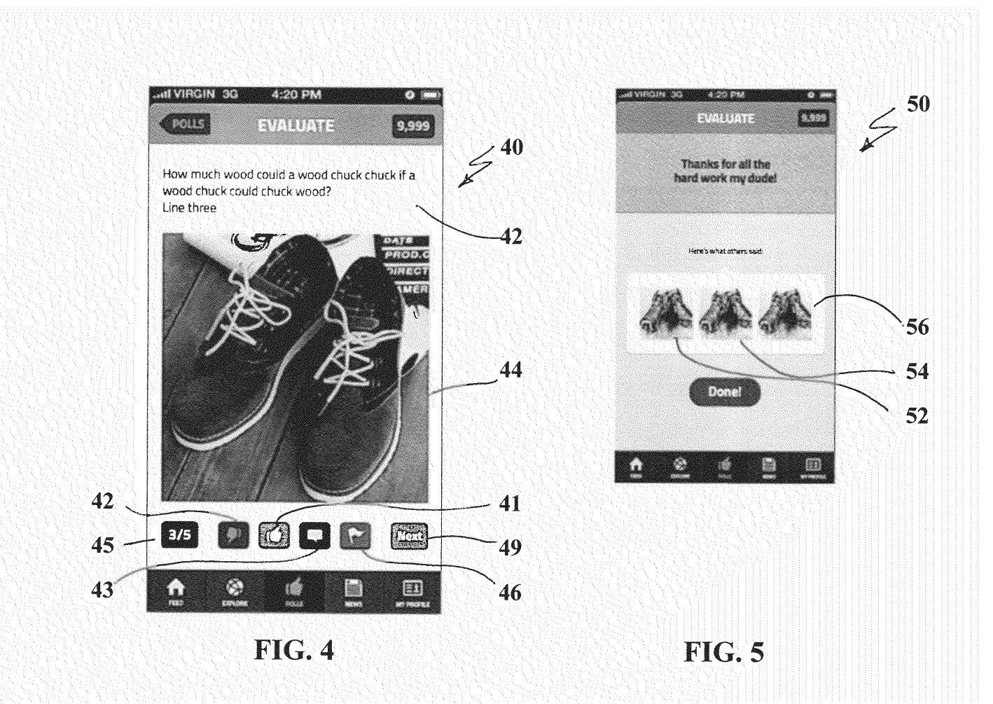

In some embodiments, the evaluator provides qualitative reviews of each response and assigns quantitative point values to the response according to the evaluator's review and a rubric for assigning points. In some cases the point values may be hidden from the evaluator. For example, FIG. 4 illustrates an exemplary mobile device screen of an evaluator's interface 40 for evaluating an image 44 of a pair of a consumer's “favorite pair of shoes” transmitted in response to a question 42: “What is your favorite pair of shoes at RST Shoe Store?”

For the purpose of illustration and not limitation, the evaluator's interface 40 may include an area 42 for displaying the question posed and an area for displaying the consumer's response 44, which, for the present example, shows an image of a pair of shoes. The evaluator's interface 40 may include a number of function keys or buttons that may include one of more of: a Thumb's up key 41, a Thumb's down key 42, a text comment key 43, a bucket display 45 (for displaying how many responses of the evaluator's current group have been completed), a flag key 46 (for flagging inappropriate comments for deletion), and a “NEXT” key 49 for indicating a desire to evaluate the next item in a current bucket or a desire to receive another bucket to evaluate.

An exemplary point scale for evaluating responses may include the following options, which can be broken down into an overall impression (Thumbs up or Thumbs down) as well as an assessment of the value of any textual comments:
“Thumbs up”—worth 5 points
“Thumbs down”—worth 0 points
Positive comment—worth 5 points
Neutral comment—worth 2 points
Negative comment—worth 1 point

Overall impressions may be recorded by the evaluator, e.g., pressing either the Thumb's up key 41 or the Thumb's down key 42. In implementations in which textual comments are provided and, hence, can be assessed, e.g., as positive, neutral or negative, the system may use a sentiment analysis algorithm for opinion mining, which is widely used.

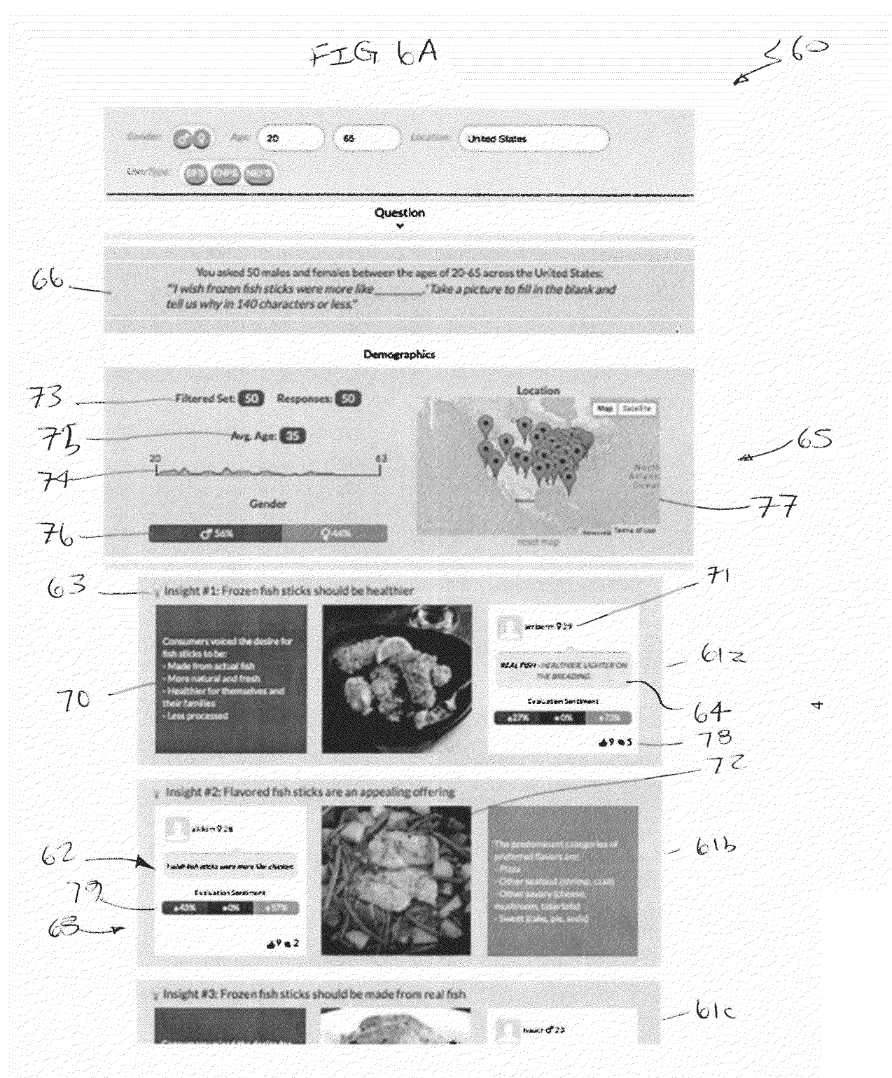

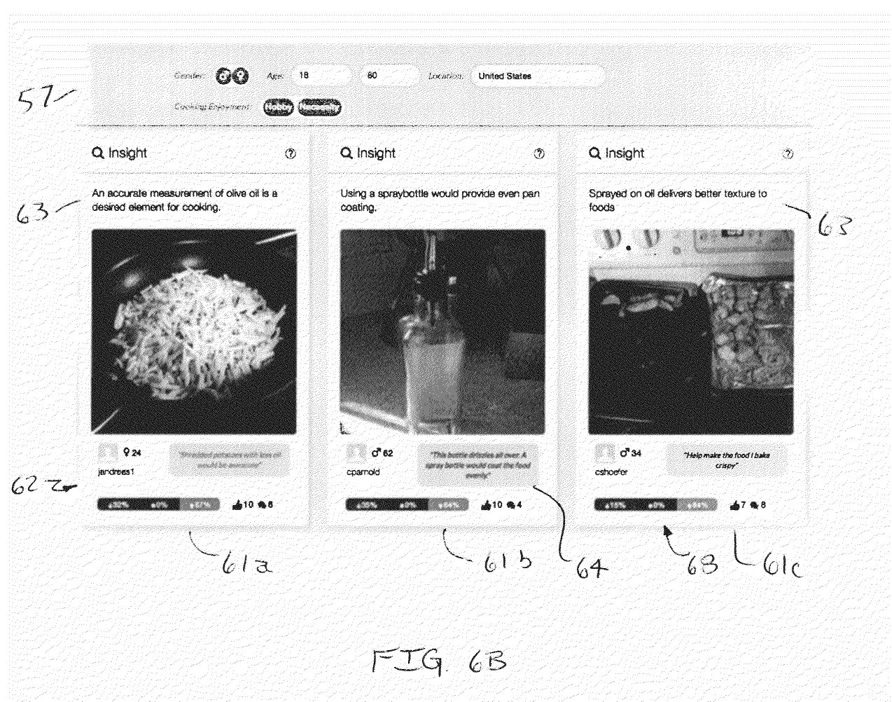

Advantageously, to further engage consumers, in some embodiments, the system may be adapted to displays responses from other targeted consumers—especially consumers with whom a consumer is “related”—to a common poll question. For example, FIG. 5 illustrates an exemplary mobile device screen capture 50 that shows responses 52, 54, 56 from three other consumers. The display of other consumers' responses—especially consumers with whom a consumer is “related”—may be a reward for a current consumer responding to the common poll.

### Insight Tagging

Optionally or alternatively, in addition to the evaluation process described above, the system may also be adapted to use a crowd-sourced panel, e.g., Amazon's Mechanical Turk and the like, to tag insights to each response. For example, to the poll question: “Show us where in your house you keep your favorite chair,” a response might be tagged with a human-readable text, i.e., an insight, such as “Next to large windows with a view is important” or “dim-mood lighting is preferred.”

### Summarization and Reporting

After each response has been rated by a pre-designated number of evaluators, the system may calculate an average points per content element by, for example, dividing the total number of points from all evaluators by the number of evaluations. In addition, the system may calculate a frequency of a particular insight tagging. Both the insight tagging frequency and the average points per piece of content may then be used to rank the content.

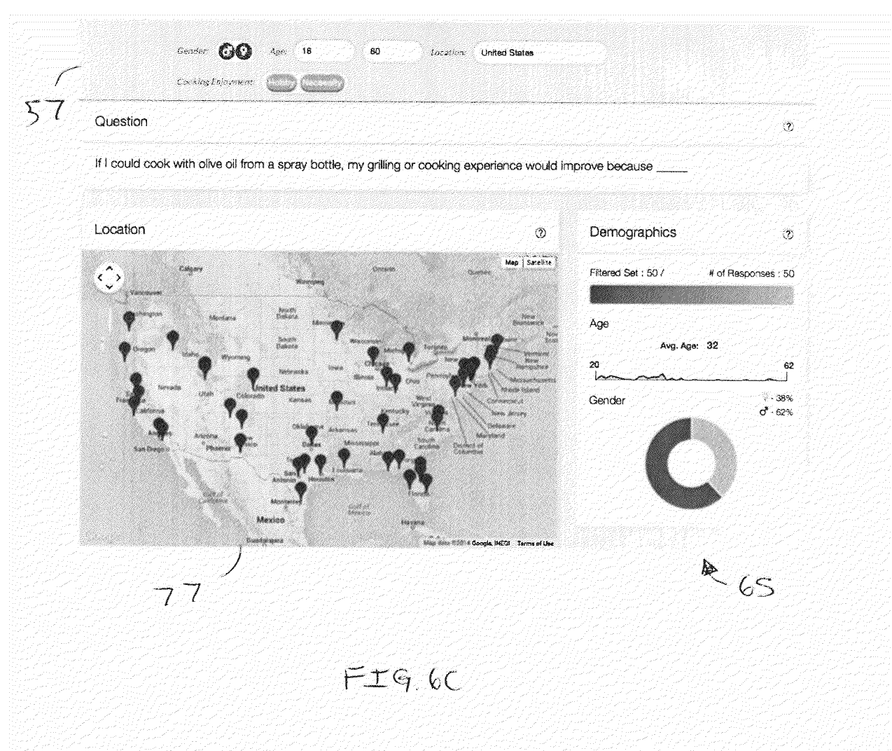

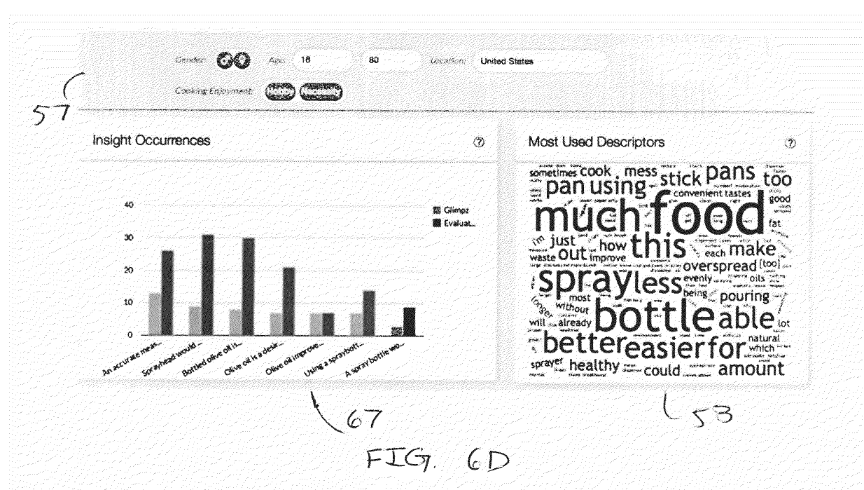

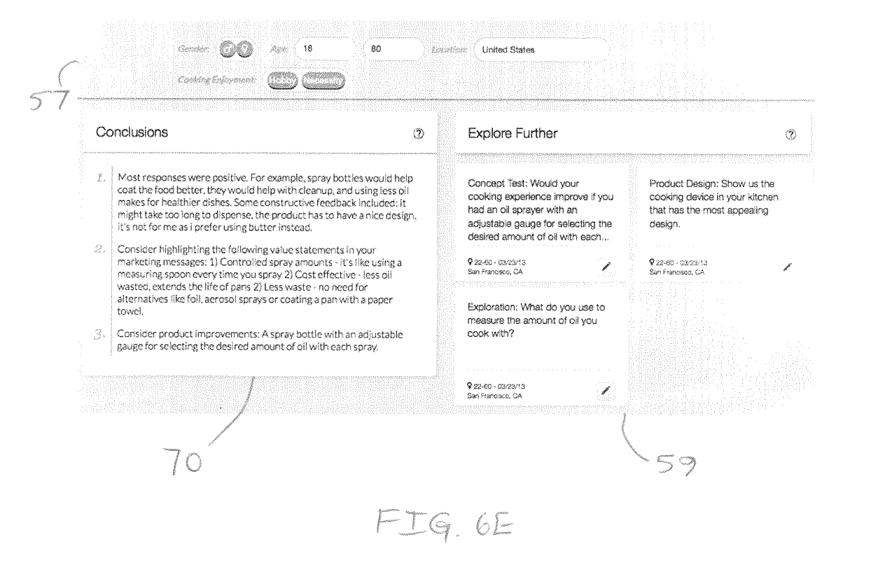

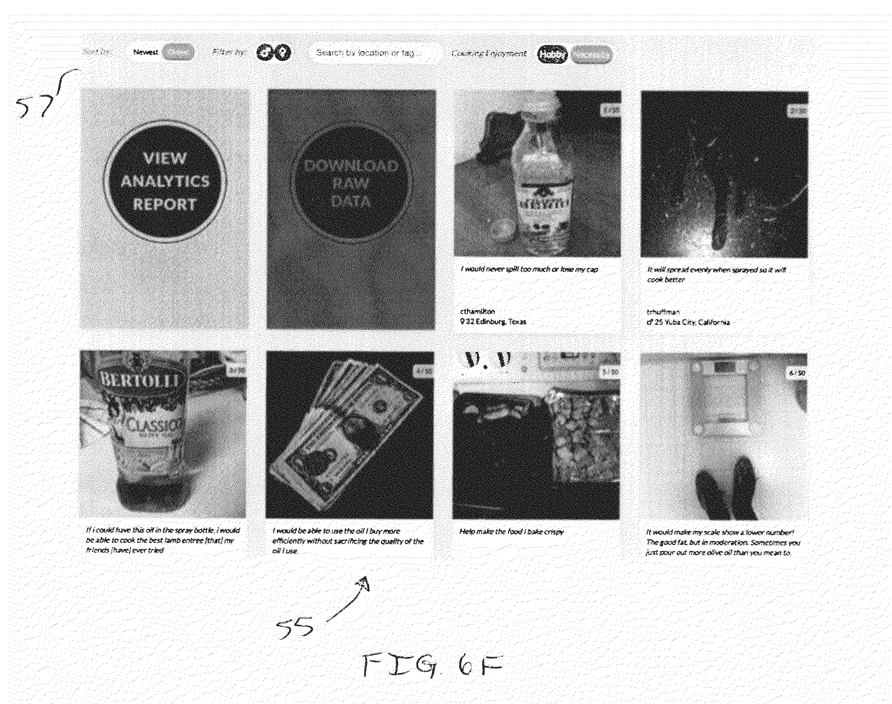

In some embodiments, the system may also be adapted to summarize these data and to provide summary reports. Summary reports may be delivered using email or application screens to the polling user and/or may be available on the system through the network. FIGS. 6A through 6F illustrate exemplary Web pages and/or mobile device screen captures of various embodiments of a poll summary 60. FIG. 6A shows an exemplary Web page and/or mobile device screen capture of a complete summary report 60; whereas FIGS. 6B through 6E show particular portions of the complete summary report 60. Referring to FIG. 6A, for illustrative purposes only and not for the purposes of limitation a summary report 60 may include: 1) a prominent display of the consumer responses 61a, 61b, 61c that received the most points, e.g., the top three, along with evaluation information 62 and insight tagging 63 (See also FIG. 6B); 2) word clouds 64 (FIG. 6B) displaying the nature of the text responses as well as a graphic of most often used descriptors 58 (FIG. 6D); 3) demographic information 65 (FIG. 6C) of all consumers who responded to the poll question 66; 4) an insight occurrence graph 67 (FIG. 6D) showing the frequency of various insights occurring in the response data; 5) metrics 68 (FIG. 6B) that describe how well the content resonated with the evaluators and, optionally, how likely the content is to go viral; 6) summarized conclusions 70 (FIG. 6E) of the poll; and 7) suggestions on further research topics 59 to explore (FIG. 6E). Each displayed consumer response 61a, 61b, 61c may include portions that show consumer identification information 71 as well as the image 72 transmitted by the consumer. Displayed demographic information 65 can include, the number of responses received 73; a graphic display 77 of the geographical distribution of responses; an age distribution graph 74 as well as a calculated average age 75 of responding consumers; and/or a gender distribution graphic 76. Metrics 68 describing how well the content resonated with the evaluators may include a summary of the number of “thumbs up” and “thumbs down” 78 and an evaluation sentiment (i.e., positive, neutral, and negative) distribution 79.

Various portions of the summary report may be interactive in nature. For example, the system may be adapted to enable polling users to create filtered sets of responses that will regenerate the entire summary report or a subset of the entire summary report using only selected responses. For example, polling users might want to further filter responding consumers into sets based on age, such as consumer ages 18-30 and ages 30-60. To facilitate filtering, interactive controls 57 may be provided on or embedded into the complete summary report 60 (FIG. 6A) or into any of the portions of the summary report (FIG. 6B through 6F). Filtered data can be automatically processed to populate an updated summary report 60 and, subsequently, reviewed by the polling user to understand, for example, any differences between the two age groups. The system may also be adapted to enable polling users to drill down to view additional details about the top three or to view other responses that were not in the top three.

In addition to the summary reports 60, raw response data (the images 72 and short text messages 64), may be annotated or tagged with some of the characteristics of the consumer who provided the content such as demographic, psychographic, attitudinal, and behavioral data, which may be provided to the polling user. Similarly, raw response data 55 (FIG. 6F) may be filtered given an available set of filtering parameters similar to those described above.

In one particular implementation, the system may be integrated with social networking applications such as Facebook, Twitter, LinkedIn, Instagram, and the like. If allowed by a responding consumer, data provided to and/or published on social networking sites such as standard demographics, schools attended, pages “liked”, people followed, and so forth, may be included with the responding consumer's content, reviews, and responses.

In summary, the systems and techniques described herein offer a completely integrated polling and analysis service that provides a visual summary of data from a plurality for consumer's in response to specific questions in real time. Advantageously, polling questions and responses may be transmitted using handheld mobile devices. As a result, the system provides accurate, verifiable data and, moreover, identifies more details about a particular situation because the responses include both text and visual content.

Indeed, as a result of combining text and visual images and facilitating reviews and evaluations of responses to polling questions, true consumer sentiment is discovered and confirmed, which opens up additional opportunities. For example, the system enables an independent facility to perform an event audit. For example, the ABC Coffee Shop or other retailers may poll consumers: “Is there something you find unappealing in our facility?” and may receive meaningful responses that can be evaluated using a crowd-sourced model. Another example of use is connection with the provision and confirmation of real-time location information, such as: “How long is the line at the Bellevue DMV?” or “What is the crowd like in a Trinity Club?” Advantageously, polling users may use the data results from such poll questions to determine when to leave for the location.

### Illustrative System Architecture

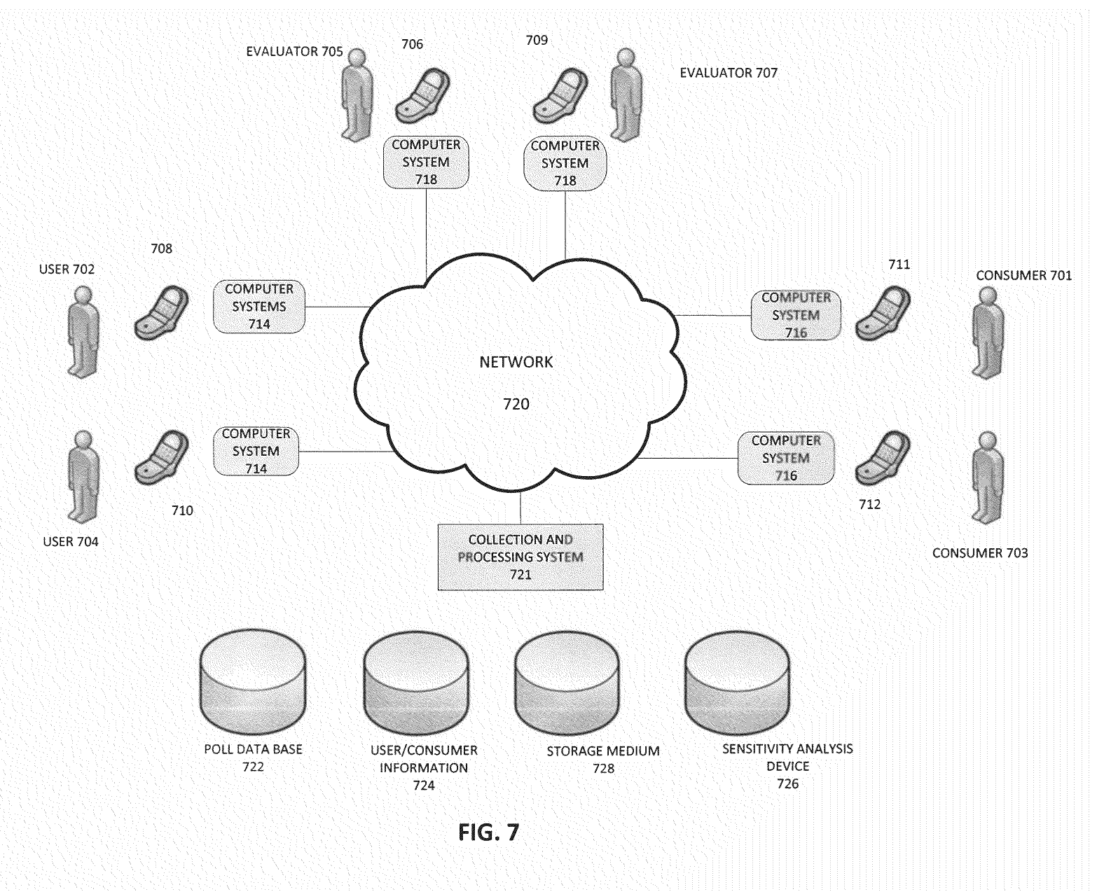

FIG. 7 shows a context diagram of a distributed system 700 configured to provide a crowd-based polling platform in accordance with some of the embodiments of the present invention. The particular configuration of the system 700 depicted in FIG. 7 is used for illustration purposes only and embodiments of the invention may be practiced in other contexts. Thus, the invention is not limited to a specific number of network users or systems.

Referring to FIG. 7, system 700 may include users 702 and 704, consumers 701 and 703, and evaluators 705 and 707, user interfaces 708 and 710, consumer interfaces 711 and 712, evaluator interfaces 706 and 709, computer systems 714, 716, and 718, a communications network 720, collection and processing system 721, a poll database 722, a user/consumer database 724, a sensitivity analysis system 726, and memory 728. The system 700 is configured and arranged to enable users 702 and 704 to interact with user interfaces 708 and 710, respectively; to enable consumers 701 and 703 to interact with consumer interfaces 771 and 712, respectively; and to enable evaluators 705 and 707 to interact with evaluator interfaces 706 and 709, respectively. The system 700 may also be adapted to enable a collection and processing system 721 to interact with the poll database 722, the user/consumer database 724, the sensitivity analysis system 726, and the memory 728.

According to the depicted embodiment, interfaces 708, 710, 711, 712, 706, and 709 may be browser-based user interfaces served by the collection and processing system 722 and may be rendered by computer systems 714, 716, and 718, e.g., via a software application (“app”) executed by a processing device that is disposed on a mobile cellular telephone, smartphone, tablet computer, and the like. Computer systems 714, 716, and 718 may be interconnected and operationally and electronically coupled with one another as well as with the collection and processing system 721 via the network 720. The network 720 may include any communication network through which member computer systems may exchange data, e.g., the World, Wide Web, the Internet, an intranet, a wide area network (WAN), a local area network (LAN), a cellular telephone network, and so forth.

The sundry computer systems shown in FIG. 7 (and discussed in greater detail in the next section), which include computer systems 714, 716, and 718, the network 720, and the collection and processing system 721, each may include one or more processing systems. Each processing system may have one or more processing devices, processors, or controllers as well as memory and an interface device(s), e.g., for input and output.

The collection and processing system 721 may be adapted to manage and orchestrate communications between one or more polling users 702 and 704, a plurality of consumers 701 and 703, and a plurality of evaluators 705 and 707. In the illustrated embodiment, the collection and processing system 721 may provide user interfaces 708 and 710 to users 702 and 704, respectively; consumer interfaces 711 and 712 to consumers 701 and 703, respectively; and evaluator interfaces 706 and 709 to evaluators 705 and 707, respectively. Alternatively, the interfaces may be provided by an app executed on the computer systems 714, 716 and 718, which computer system could be a cellular telephone, tablet computer, and the like. In variations of some embodiments, interfaces 708, 710, 711, 712, 706, and 709 may be presented via a network 720 on computer systems 714, 716, and 718, respectively.

As discussed herein, the collection and processing system 721 is adapted to enable polling users 702 and 704 to ask, pose, and/or post a poll question; store the poll question, e.g., in a poll database 722; intelligently identify a pool of consumers who are likely to respond to the poll, e.g., using a consumer information database 724; transmit the poll question to and receive a response(s) to the poll question from responding consumers 701 and 703 from among the identified pool of consumers; process the response data, which can include text data as well as image data; provide the processed response data to and receive evaluations for each poll response from each of the plurality of evaluators 705 and 707; perform sensitivity analysis on the raw data, e.g., using a sensitivity analysis algorithm 726; process and store the raw response data, sensitivity analysis results, and poll evaluations, e.g., in a storage medium 728, for the purpose of summarizing the results in a meaningful format; provide poll summary reports to each polling user 702 and 704 in a format that enables user 702 and 704 to manipulate and filter the raw data summarized, e.g., to present a subset of summary reports; and enable and facilitate users 702 and 704 to perform such manipulation and filtering.

In various embodiments, the collection and processing system 721 may receive consumer information data (for storage in the consumer information database 724) from a variety of sources and may use it in polling events involving the users 702 and 704 and consumers 701 and 703. Consumer information data may include any current or past data related to the consumer as an individual, e.g., consumer demographics, consumer geographical location, consumer psychographic characteristics, consumer attitudinal characteristics, consumer behavioral characteristics, and consumer interests; personal and social media contact data on the consumer, e.g., the consumer's name, all social media used by the consumer, the consumer's friends, fans, and others with whom the consumer is “related” (i.e., has an established association via a social network), at least one of a consumer's email addresses, a consumer's telephone number, and a consumer's cellphone number; as well as current or past data related to the consumer as a responding consumer to polling questions, e.g., historical consumer response times, historical consumer response frequency, determining historical consumer drop off patterns of a discrete consumer; a number of polls started by the consumer, a number of polls completed by the consumer, a number of polls partially completed by the consumer, and a number of searches and search frequency of the consumer for a new poll to respond to.

In other embodiments, the collection and processing system 721 may exchange data with third parties. As a result, the “community” or pool of consumers may be built or assembled through partnerships with research firms, brands, product manufacturers, and the like. For example, a brand may own a database of platform-specific or application-specific consumer usernames, consumer names, consumer email addresses, and/or consumer cellphone numbers that the brand may be willing to share.

### Computer System

As used herein, references to “computer(s),” “machine(s)” “systems” and/or “device(s),” may include, without limitation, a general purpose computer that includes a processing unit, a system memory, and a system bus that couples various system components including the system memory and the processing unit. The general purpose computer may employ the processing unit to execute computer-executable program modules stored on one or more computer readable media forming the system memory. The program modules may include instructions, routines, programs, objects, components, data structures, etc. that perform particular tasks or implement particular abstract data types.

The “computer(s),” “machine(s)” and/or “device(s),” may assume different configurations and still be consistent with the invention, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

Moreover, as used herein, references to “a module(s),” “application(s),” “function(s),” and/or “algorithm(s)” generally refer to, but are not limited to, a software or hardware component that performs certain tasks. For example, a module may advantageously be configured to reside on an addressable storage medium and be configured to execute on one or more processors. A module may be fully or partially implemented with a general purpose integrated circuit (IC), co-processor, field-programmable gate array (FPGA), or application-specific integrated circuit (ASIC). Thus, a module may include, by way of example, components, such as software components, object-oriented software components, class libraries, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or be further separated into additional components and modules. Additionally, the components and modules may advantageously be implemented on many different platforms, including computers, computer servers, data communications infrastructure equipment such as application-enabled switches or routers, or telecommunications infrastructure equipment, such as public or private telephone switches or private branch exchanges (PBX). In any of these cases, implementation may be achieved either by writing applications that are native to the chosen platform, or by interfacing the platform to one or more external application engines.

Various aspects and functions described herein in accord with the present invention may be implemented as hardware or software on one or more computer systems. Of particular interest in connection with some embodiments of the present invention, computer systems include mobile computing devices, such as cellular phones, smartphones, tablet computers, personal digital assistants, and the like. Other examples of computer systems currently in use include network appliances, personal computers, workstations, mainframes, networked clients, servers, media servers, application servers, database servers, and web servers. Other examples of computer systems may include network equipment, such as load balancers, routers, and switches. Furthermore, aspects in accord with the present invention may be located on a single computer system or may be distributed among multiple computer systems connected to one or more communications networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Thus, the invention is not limited to executing on any particular system or group of systems. Moreover, aspects may be implemented in software, hardware or firmware, or any combination thereof. Thus, aspects in accord with the present invention may be implemented within methods, acts, systems, system elements, and components using a variety of hardware and software configurations, and the invention is not limited to any particular distributed architecture, network, or communication protocol.

Computer systems 714, 716, 718 and the collection and processing system 721 are interconnected by, and are adapted to exchange data through, a communication network 720. Networks consistent with exemplary embodiments of the invention, including network 720, may be a wired or wireless local area network (LAN) or wide area network (WAN), a wireless personal area network (PAN), and other types of networks. When used in a LAN networking environment, computers (such as a computer executing the application, or the client device) may be connected to the LAN through a network interface or adapter. When used in a WAN networking environment, computers typically include a modem or other communication mechanism. Modems may be internal or external, and may be connected to the system bus via a user-input interface, or other appropriate mechanism. Network 720 can include any communication network through which computer systems 714, 716, 718 and the collection and processing system 721 can exchange data, e.g., the Internet, an Intranet, an Extranet, an Ethernet, or any other network that facilitates communications.

To exchange data using network 720, computer systems 714, 716, 718 and the collection and processing system 721, and network 720 may use various methods, protocols, and standards, including, inter alia, token ring, Ethernet, Hyper-Text Transfer Protocol (HTTP), File Transfer Protocol (FTP), and Simple Network management Protocol (SNMP), User Datagram Protocol (UDP), Transmission Control Protocol (TCP), Venturi Transport Protocol (VTP), Datagram Congestion Control Protocol (DCCP), Fiber Channel Protocol (FCP), Stream Control Transmission Protocol (SCTP), Reliable User Datagram Protocol (RUDP), and Resource ReSerVation Protocol (RSVP). To ensure data transfer is secure, computer systems 714, 716, 718 and the collection and processing system 721 may transmit data via network 720 using a variety of security measures including TLS, SSL, and/or other security techniques. For wireless communications, communications protocols may include Bluetooth, Zigbee, IrDa, or other suitable protocol. Furthermore, components of the systems described herein may communicate through a combination of wired or wireless paths.

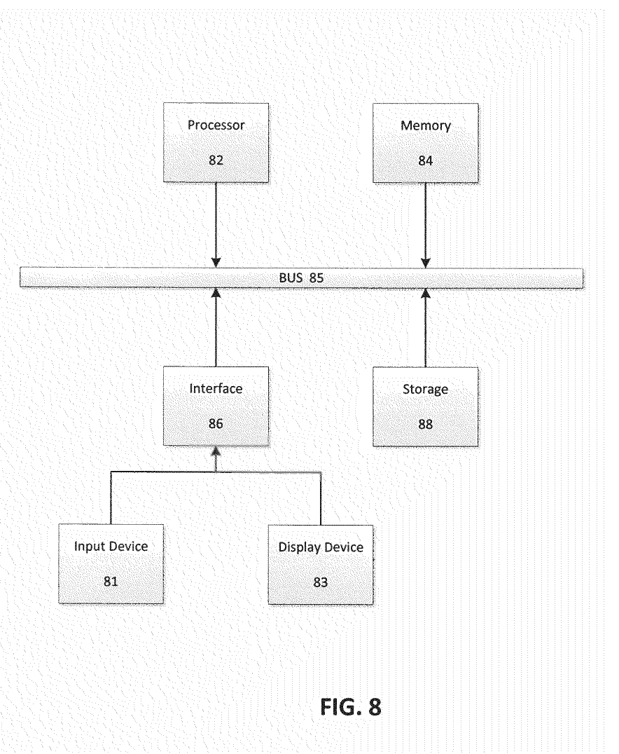

Various aspects and functions in accordance with the present invention may be implemented as specialized hardware or software executing in one or more computer systems including computer system 80 shown in FIG. 8. Computer system 80 may include a processing device (“processor”) 82, a first data storage device(s) (“memory”) 84, an interface 86, and a second data storage device(s) (“storage”) 88. The processor 82 and the other elements may be interconnected electrically and electronically via a bus 85. The processor 82 may be a commercially available processor such as an Intel Core, Motorola PowerPC, MIPS, UltraSPARC, or Hewlett-Packard PA-RISC processor, but may be any type of processor or controller as many other processors and controllers are available. The processor 82 is structured and arranged to perform a series of instructions, e.g., an application, an algorithm, a driver program, and the like, that result in manipulated data.

Memory 84 may be used for storing programs and data during operation of computer system 80. Thus, memory 84 may be a relatively high performance, volatile, random access memory such as a dynamic random access memory (DRAM) or static memory (SRAM). However, memory 84 may include any device for storing data, such as a disk drive, flash memory or other non-volatile storage device. Various embodiments in accord with the present invention may organize memory 84 into particularized and, in some cases, unique structures to perform the aspects and functions disclosed herein.

Components of the computer system 80 may be coupled by an interconnection element such as a bus 85. The bus 85 may include one or more physical busses (for example, between components that are integrated within a same machine), but may include any communication coupling between system elements including specialized or standard computing bus technologies such as IDE, SCSI, PCI, and InfiniBand. Thus, the bus 85 enables communications, e.g., the transfer of data and instructions, to be exchanged between components of the computer system 80.

Computer system 80 may also include one or more interface devices 86 such as input devices, output devices, and combined input/output devices. Interface devices allow computer system 80 to exchange information and communicate with external entities, such as users, consumers, evaluators, and other systems. Interface devices 86 are adapted to receive input or to provide output. More particularly, output devices may render information for external presentation, for example, on display devices 83. Input devices 81 may accept information from external sources. Examples of interface devices 86 include keyboards, mouse devices, trackballs, microphones, touch screens, printing devices, display screens, speakers, network interface cards, and so forth.

The second data storage device 88 may include a computer readable and writeable nonvolatile storage medium in which instructions are stored that define a program, application, algorithm, and the like to be executed by the processor 82. Storage system 88 also may include information that is recorded on or in the medium, and this information may be processed by the program, application, algorithm, and the like. More specifically, the information may be stored in one or more data structures specifically configured to conserve storage space and/or to increase data exchange performance. The instructions may be persistently stored as encoded signals, and the instructions may cause a processor 82 to perform any of the functions described herein. The data storage medium may, for example, be optical disk, magnetic disk or flash memory, among others.

In operation, the processor 82 or some other controller may cause data to be read from the nonvolatile recording medium, i.e., the second data storage device 88, into another data storage device, such as memory 84, to allow for faster access to the information by the processor 82. Such data storage may be located in the second data storage device 88 and/or in memory 84. The processor 82 also may manipulate the data within the memory 84, and then copy the data to the medium associated with the second data storage device 88 after processing is completed. A variety of components may manage data movement between the medium and integrated circuit memory element and the invention is not limited thereto. Further, the invention is not limited to a particular memory system or storage system.

Although the computer system 80 is shown by way of example as one type of computer system upon which various aspects and functions in accord with the present invention may be practiced, aspects of the invention are not limited to being implemented on the computer system 80 as shown in FIG. 8. Various aspects and functions in accord with the present invention may be practiced on one or more computers having different architectures or components than those shown in FIG. 8. For instance, computer system 80 may include specially-programmed, special-purpose hardware, such as for example, an application-specific integrated circuit (ASIC) tailored to perform a particular operation disclosed herein. While another embodiment may perform the same function using several general-purpose computing devices running MAC OS System X with Motorola PowerPC processors and several specialized computing devices running proprietary hardware and operating systems.

The computer system 80 may be a computer system including an operating system that manages at least a portion of the hardware elements included in the computer system 80. Usually, a processor or controller, such as processor 82, executes an operating system which may be, for example: a Windows-based operating system, e.g., Windows 7, Windows 2000 (Windows ME), Windows XP operating systems, and the like, available from the Microsoft Corporation, a MAC OS System X operating system available from Apple Computer, one of many Linux-based operating system distributions, e.g., the Enterprise Linux operating system, available from Red Hat Inc., or a UNIX operating system available from various sources. Many other operating systems may be used, and embodiments are not limited to any particular implementation.

The processor 82 and operating system together define a computer platform for which application programs in high-level programming languages may be written. These component applications may be executable, intermediate (e.g., C-), or interpreted code which communicate over a communication network, e.g., the Internet, using a communication protocol, e.g., TCP/IP. Similarly, aspects in accordance with the present invention may be implemented using an object-oriented programming language, such as SmallTalk, Java, C++, Ada, or C# (C-Sharp). Other object-oriented programming languages may also be used. Alternatively, functional, scripting, or logical programming languages may be used.

Additionally, various aspects and functions in accord with the present invention may be implemented in a non-programmed environment, e.g., documents created in HTML, XML or other format that, when viewed in a window of a browser program, render aspects of a graphical-user interface or perform other functions. Furthermore, various embodiments in accordance with the present invention may be implemented as programmed or non-programmed elements, or as any combination thereof. For example, a Web page may be implemented using HTML while a data object called from within the Web page may be written in C++. Thus, the invention is not limited to a specific programming language. Indeed, any suitable programming language could be used.

A computer system included within an embodiment may perform functions outside the scope of the invention. For instance, aspects of the system may be implemented using an existing commercial product, such as, for example, Database Management Systems such as SQL Server available from Microsoft of Seattle, Wash., Oracle Database from Oracle of Redwood Shores, Calif., and MySQL from MySQL AB of Uppsala, Sweden or integration software such as Web Sphere middleware from IBM of Armonk, N.Y. However, a computer system running, for example, SQL Server may be able to support both aspects in accordance with the present invention and databases for sundry applications not within the scope of the invention.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as illustrative and not restrictive. The configurations, materials, and dimensions described herein are also intended as illustrative and in no way limiting. Similarly, although physical explanations have been provided for explanatory purposes, there is no intent to be bound by any particular theory or mechanism, or to limit the claims in accordance therewith.

What is claimed is:

1. A method for facilitating visual feedback and analysis over a network including a memory and a processing device, the network having a plurality of users, each user of the plurality of users having a communication device, the method comprising:
facilitating, using the processor, posting at least one question to a selected plurality of consumers via the network;
receiving, via the network using the processor, at least one response to each of the at least one question from each responding consumer from the selected plurality of users, wherein the at least one response comprises a text message and at least one image;
categorizing, using the processor, the at last one response from each responding consumer;
evaluating, using the processor, all responses in each category of responses by assigning a pre-established quantitative point value to each response; and
ranking, using the processor, all responses using the quantitative point value.

2. The method of claim 1, wherein posting at least one question to a selected plurality of consumers includes identifying a community of consumers likely to review and to respond to the at least one question.

3. The method of claim 2, wherein a likelihood of review and response among the community of consumers is based on consumer data selected from the group consisting of consumer demographics, consumer location, consumer psychographic characteristics, consumer attitudinal characteristics, consumer behavioral characteristics, historical consumer response times, historical consumer response frequency, and consumer interests.

4. The method of claim 2, wherein a likelihood of review and response among the community of consumers is based on collected consumer names and at least one of a consumer's email addresses, a consumer's telephone number, and a consumer's cellphone number.

5. The method of claim 2, wherein a likelihood of review and response among the community of consumers is based on an election by a discrete consumer to participate.

6. The method of claim 5, wherein the election results from at least one of a query to participate or from a consumer subscription to participate.

7. The method of claim 1 further comprising tagging at least one insight to each image of the at least one image.

8. The method of claim 1 further comprising:
determining a frequency of substantially similar insight tagging; and
ranking all responses using insight tagging frequency.

9. The method of claim 1 further comprising maintaining consumer engagement by minimizing idle time.

10. The method of claim 9, wherein minimizing idle time includes at least one of:
determining historical consumer drop off patterns of a discrete consumer;
determining a number of polls started by the discrete consumer;
determining a number of polls completed by the discrete consumer;
determining a number of polls partially completed by the discrete consumer;
determining a number of followers of the discrete consumer;
determining a number of fans of the discrete consumer; and
determining a number of instances the discrete consumer conducts a search for a new poll to respond to.

11. The method of claim 9 wherein minimizing idle time includes enabling a discrete consumer to view at least one of a poll response of a consumer with whom the discrete consumer is linked via a social medium and evaluations of poll responses of a consumer with whom the discrete consumer is linked via a social medium.

12. The method of claim 1, wherein the posting and the receiving are done synchronously.

13. The method of claim 1, wherein the posting and the receiving are done asynchronously.

14. The method of claim 13, wherein asynchronous posting and receiving includes:
ascertaining a discrete consumer's location with respect to a predetermined location;
establishing a geographical radius about the predetermined location; and
posting the at least one question to the discrete consumer when the discrete consumer's location is within the geographical radius about the predetermined location.

15. The method of claim 14 further comprising periodically tracking the discrete consumer's location.

16. The method of claim 14 further comprising:
continuously tracking the discrete consumer's location; and
establishing a time boundary about continuous tracking,
wherein the time boundary is established between a first time at which the discrete consumer receives a poll and a second time at which the discrete consumer provides a response to the poll.

17. The method of claim 1, wherein the at least one image is selected from the group consisting of a picture, a plurality of pictures, and a video.

18. The method of claim 1 further comprising rewarding each responding consumer commensurate with the point value assigned to the responding consumer's response.

19. The method of claim 18, wherein rewarding each responding consumer includes providing each responding consumer with a reward redeemable at a specific business location.

20. The method of claim 1 further comprising applying a value multiplier to the pre-established quantitative point value to each response.

21. The method of claim 20, wherein the value multiplier includes at least one of: a first multiplier to account for timeliness of a response, a second multiplier to account for a more positive response, and a third, negative multiplier to account for a more negative response.

22. The method of claim 1 further comprising rewarding each consumer of the plurality of consumers for at least one of: providing personal profile information, referring other consumers to sign up, and participating in social media.

23. A system for facilitating visual feedback and analysis over a network including a memory and a processing device, the network having a plurality of users, each user of the plurality of users having a communication device, the system comprising:
a non-transitory machine-readable medium storing information; and
at least one data processor that is adapted to execute instructions stored in the non-transitory machine-readable medium and that is configured to:
facilitate posting at least one question to a selected plurality of consumers via the network;
receive, via the network, at least one response to each of the at least one question from each responding consumer from the selected plurality of consumers, wherein the at least one response comprises a text message and at least one image;
categorize the at last one response from each responding consumer;
evaluate all responses in each category of responses by assigning a pre-established quantitative point value to each response; and
rank all responses using the quantitative point value.

24. The system of claim 23, wherein the at least one data processor is further configured to tag at least one insight to each image of the at least one image.

25. The system of claim 23, wherein the at least one data processor is further configured to:
determine a frequency of substantially similar insight tagging; and
rank all responses using insight tagging frequency.

26. The system of claim 23, wherein the at least one data processor is further configured to maintain consumer engagement by minimizing idle time.

27. The system of claim 23, wherein the at least one data processor is further configured to periodically track a discrete consumer's location.

28. The system of claim 23, wherein the at least one data processor is further configured to:
continuously track the discrete consumer's location; and
establish a time boundary about continuous tracking,
wherein the time boundary is established between a first time at which the discrete consumer receives a poll and a second time at which the discrete consumer provides a response to the poll.

29. The system of claim 23, wherein the at least one data processor is further configured to reward each responding consumer commensurate with the point value assigned to the responding consumer's response.

30. The system of claim 23, wherein the at least one data processor is further configured to apply a value multiplier to the pre-established quantitative point value to each response.

31. The system of claim 23, wherein the at least one data processor is further configured to reward each consumer of the plurality of consumers for at least one of: providing personal profile information, referring other consumers to sign up, and participating in social media.
